(19) United States
(12) Patent Application Publication
(10) Pub. No.: US 2025/0033079 A1
(43) Pub. Date: Jan. 30, 2025

(54) Dosing Process With Alternating Supply, and Associated Devices

(71) Applicant: Exel Industries, Epernay (FR)

(72) Inventors: Philippe de Talhouet, Paris (FR); Thibault Cognon, Clichy (FR)

(21) Appl. No.: 18/781,876

(22) Filed: Jul. 23, 2024

(30) Foreign Application Priority Data
Jul. 24, 2023 (FR) 2307954

(51) Int. Cl. B05C 11/10

(52) U.S. Cl. CPC B05C 11/1036; B05C 11/1026

(57) ABSTRACT

The present invention relates to a metering method for a multi-component coating product for application, comprising the following steps:
provision of a metering device comprising a metering pump and respective component product supply channels, each component product supply channel being provided with a respective valve having a closed and an open configuration, the outlet being suitable for being connected to a coating product applicator; and
suction by the metering pump of a volume during a suction phase of the metering pump, at least two of the respective valves being alternately, one after the other, in the open configuration during suction, in such a way that the volume sucked-in during said suction phase comprises alternately a plurality of component products.

The invention further relates to an associated metering device and application device.

### CROSS-REFERENCE TO RELATED APPLICATION(S)

This application claims the benefit of FR 2307954 filed on Jul. 24, 2023, which is incorporated herein by reference in its entirety.

### BACKGROUND

The present invention relates to a metering method for a multi-component product and related devices.

The multi-component product consists e.g. of a plurality of components which are mixed, in particular in given proportions.

Document FR 2 928 466 A1 describes a method for controlling a metering device, comprising a first pump for injecting a dose of a first component into a mixer, and a second pump for injecting a dose of a second component into the mixer.

However, such system requires a pump apt to meter each component of the multi-component product.

Moreover, the mixing is carried out only at the mixer.

The goal of the invention is then to propose a simpler metering method which would make an improved mixing possible.

### SUMMARY

To this end, the subject matter of the invention relates to a method for a multi-component coating product for application, comprising the following steps:
provision of a metering device comprising a metering pump and a plurality of supply channels for the respective component product, the metering pump having an inlet and an outlet, the inlet being connected to the plurality of supply channels for the respective component product, each component product supply channel being provided with a respective valve, each valve having at least one closed configuration, wherein the valve prevents the passage of the corresponding component product to the inlet, and at least one open configuration, wherein the valve permits the passage of the corresponding component product to the inlet, the outlet being suitable for being connected to a coating product applicator, and
suction by the metering pump of a volume during a suction phase of the metering pump, at least two of the respective valves being alternately, one after the other, in the open configuration during suction, in such a way that the volume sucked-in during said suction phase comprises alternately a plurality of component products.

The metering device comprises only one metering pump, so that the device is simpler, the selective choice of the supply channel being achieved by a selective opening of the corresponding supply channel. Furthermore, the component products are already in contact in the metering pump. By alternating the component products in the inlet volume of the metering pump, it is possible to have the different components directly one after the other, cyclically, which enhances mixing.

According to other advantageous aspects of the invention, the metering method comprises one or a plurality of the following features, taken individually or according to all technically possible combinations:
the metering device comprises at least two supply channels for the respective component product, a gas supply channel, and a solvent supply channel;
the multi-component product consists of a given number of component products, the suction comprising, in the present order, the following steps: opening of a first valve of the supply channel of a first component product, suction of a first volume of the first component product by the metering pump, closing of the first valve, opening of a second valve in the supply channel of a second component product, suction of a second volume of the second component product by the metering pump, closing of the second valve, and so on until the valve of the given number, said preceding steps being repeated throughout the suction phase,
the suction comprises a suction cycle, said suction cycle being repeated throughout the suction phase, at least two of the respective valves being one after the other in the open configuration during the suction cycle;
during a suction cycle, the volume of each respective component product sucked-in is equal to the product of a respective predetermined ratio and to the total volume of respective component products sucked-in during the suction cycle, the sum of the respective ratios being equal to 1;
the metering process comprises a detection of the suction volume during the suction by the metering pump, more particularly by a sensor for the sucked-in volume or a sensor for the movement of the metering pump;
the metering pump is a piston pump;
each component product supply channel of the metering device comprises a respective secondary pump, the respective secondary pump being suitable for pumping the respective component product to the inlet of the metering pump, each respective secondary pump being arranged upstream of the respective valve of the component product supply channel; and/or
the metering device comprises a mixer downstream of the outlet of the metering pump, more particularly arranged adjacent to the outlet of the metering pump.

The invention further relates to a device for metering a multi-component product comprising a metering pump, a plurality of supply channels for the respective component product and a control module, wherein the metering pump has an inlet and an outlet, the inlet being connected to the plurality of supply channels for the respective component product, each component product supply channel being provided with a respective valve, each valve having at least one closed configuration, wherein the valve prevents the passage of the corresponding component product to the inlet, and at least one open configuration, wherein the valve permits the passage of the corresponding component product to the inlet, the outlet being suitable for being connected to a coating product applicator, the control module being apt to control the respective valves, the control module being configured to implement suction according to the suction step of the method as hereinabove.

The invention further relates to an application device for a multi-component coating product, comprising a metering device described hereinabove and a coating product applicator, the coating product applicator being connected to the outlet of the metering pump, so that the metering pump supplies the coating product applicator.

### BRIEF DESCRIPTION OF THE DRAWINGS

The invention will be clearer upon reading the following description, given only as an example, but not limited to, and making reference to the drawings wherein:

FIG. 1 is a schematic view of an example of metering device during operation, according to a first embodiment of the invention;

FIG. 2 is a schematic view of an example of metering device during operation, according to a second embodiment of the invention; and

FIG. 3 is an example of metering pump for a metering device according to the invention.

### DETAILED DESCRIPTION

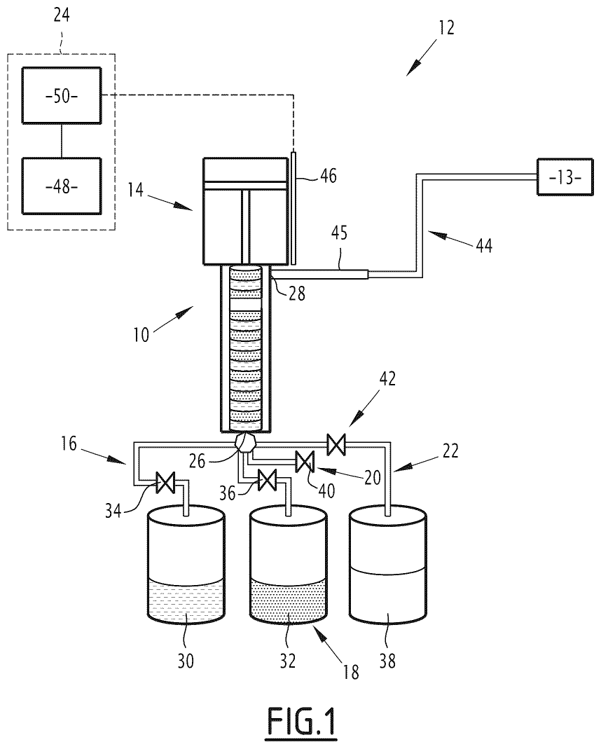

A first example of a metering device 10 for a multi-component coating product for application according to a first embodiment of the invention will now be described with reference to FIG. 1.

The multi-component coating product is e.g. a paint.

The multi-component coating product has e.g. a viscosity comprised between 100 Cps and 10,000 Cps.

The metering device 10 is herein included in a coating product application device 12.

The applicator device 12 further comprises a coating product applicator 13.

The metering device 10 comprises a metering pump 14 and a plurality of supply channels 16, 18 for the respective component product.

The metering device 10 herein further comprises a gas supply channel 20 and/or at least one solvent supply channel 22, herein a gas supply channel 20 and at least one solvent supply channel 22, in the example shown, a gas supply channel 20 and a solvent supply channel 22.

The metering device 10 further comprises herein an electronic device 24.

The metering pump 14 comprises an inlet 26 and an outlet 28.

The metering pump is apt to pump a given volume of fluid, either liquid or gaseous.

The metering pump has e.g. a cylinder capacity comprised between 10 cc and 500 cc.

The metering pump has at least one suction phase.

In one embodiment, the metering pump has a suction phase and a phase without suction.

During the suction phase, a volume corresponding to the cylinder capacity of the metering pump enters the metering pump at the inlet. In addition, during the suction phase, a volume corresponding to a first portion, herein half, of the cylinder capacity of the pump exits from the pump at the outlet.

During the phase without suction, no fluid enters the metering pump at the inlet. A volume corresponding to a second portion, supplementary to the first portion, herein half, of the cylinder capacity of the pump exits from the pump at the outlet.

In the example shown, the metering pump 14 is a piston pump.

The piston pump operates with a suction phase and a phase without suction, as described hereinabove.

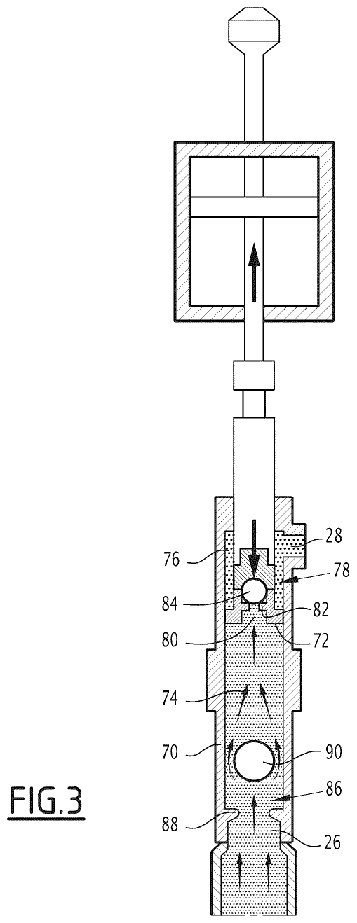

An example of a piston pump used as a metering pump 14 is, e.g., shown in FIG. 3 during the suction phase.

The metering pump comprises e.g. a cylinder 70 and a piston head 72, the piston head 72 delimiting two chambers of variable volume in the cylinder, called an upstream chamber 74 and a downstream chamber 76.

The inlet 26 is arranged opposite the outlet 28.

The inlet 26 opens out into the upstream chamber 74 opposite the downstream chamber 76, the outlet 28 opens out into the downstream chamber 76 opposite the upstream chamber 74.

The piston head 72 here is provided with a delivery valve 78.

The piston head delimits an opening 80 for the passage of fluid from the upstream chamber 74 to the downstream chamber 76, the discharge valve 78 preventing the passage of fluid from the downstream chamber 76 to the upstream chamber 74.

The discharge valve 78 comprises e.g. a seat 82 delimited by the head and surrounding the opening and a ball 84 apt to rest on the seat 82.

The piston pump is further provided with a suction valve 86 arranged at the inlet 26 of the metering pump.

The suction valve prevents fluid from leaving the metering pump at the inlet 26.

The suction valve comprises e.g. a seat 88 surrounding the inlet 26 and a ball 90 apt to rest on the seat.

During the suction phase of the metering pump, the piston head 72 moves toward the outlet 28. The volume contained in the downstream chamber 76 is expelled via the outlet 28. Furthermore, a vacuum is created in the upstream chamber 74, and a fluid is sucked in at the inlet 26, more particularly corresponding to the cylinder capacity of the pump.

More particularly, the ball 90 of the suction valve 86 moves away from the seat 88 because of the negative pressure generated in the upstream chamber 74, and the ball 84 [moves away] from the discharge valve 78 resting on the seat 82 because of the overpressure in the downstream chamber.

During the phase without suction of the metering pump, the piston head moves toward the inlet 26. No fluid enters through the inlet 26. All the volume contained in the upstream chamber 74 moves toward the downstream chamber 76. A portion of the total volume of the pump, herein half, is expelled from the downstream chamber 76 via the outlet 28.

More particularly, the ball 90 of the suction valve 86 rests on the seat 88 because of the overpressure generated in the upstream chamber 74, and the ball 84 of the discharge valve 78 moves away from the seat 82 thereof and releases the opening 80 because of the negative pressure in the downstream chamber 76.

Herein, during the suction phase, a volume corresponding to the cylinder capacity of the metering pump enters the metering pump at the inlet, and the volume corresponding to half the volume exits the pump at the outlet, and during the phase without suction, a volume corresponding to half the volume of the metering pump exits the pump at the outlet, and no fluid enters the metering pump at the inlet.

Alternatively, the metering pump comprises a piston comprising a head having no opening and defining two non-communicating chambers, including a pumping chamber. The inlet and outlet of the metering pump are arranged in the same pumping chamber. The inlet and the outlet open more particularly into the pumping chamber opposite the other chamber delimited by the head. The inlet and the outlet are e.g. each equipped with a non-return valve. The metering pump then has a suction phase, wherein the pump sucks in a volume of fluid, e.g. equivalent to the cylinder capacity of the pump, and does not expel any fluid, and a phase without suction, wherein the pump expels said volume of fluid.

As an alternative to the piston pump, the metering pump is a diaphragm pump or a ball pump.

The outlet 28 is suitable for being connected to the coating product applicator 13, so that the metering pump 14 feeds the coating product applicator.

The applicator 13 is e.g. one or a plurality of spray guns, or one or a plurality of rotary spray bowls, or one or a plurality of flow valves.

The inlet is connected to the respective plurality of component product supply channels 16, 18, and further to the gas supply channel 20 and/or the solvent supply channel 22, where appropriate.

In the example shown, a connector is arranged at the inlet 26.

The connector is e.g. a distribution unit.

The connector is connected to each of the supply channels.

Each component product supply channel 16, 18 is apt to feed the inlet of the metering pump 14 with the corresponding component product, e.g. from a respective tank 30, 32 specific to said supply channel containing the corresponding component product.

The component product supply channels 16, 18 meet e.g. upstream of the inlet at a connection point, the connection point being connected to the inlet.

The connection point is e.g. adjacent to the inlet 26.

Alternatively, each component product supply channel 16, 18 is connected to the inlet 26 separately from one another.

Each component product supply channel 16, 18 is provided with a respective valve 34, 36.

The respective valve 34, 36 is arranged upstream of the inlet 26, more particularly upstream of the connection point, where appropriate.

The respective valve 34, 36 is herein arranged downstream of the respective tank 30, 32.

Each valve 34, 36 has at least one closed configuration, wherein the valve prevents the passage of the corresponding component product through said valve, i.e. herein toward the inlet 26, and at least one open configuration, wherein the valve permits the passage of the corresponding component product through said valve, i.e. herein toward the inlet 26.

Each valve 34, 36 herein has a closed configuration and a plurality of open configurations. The flow rates of the corresponding component product through said valve differ depending on the open configurations.

Alternatively, each valve 34, 36 herein has only a closed configuration and an open configuration.

The flow rate of the corresponding component product in the supply channel is then e.g. adjustable at another location on the supply channel, e.g. with a flow rate control valve, e.g. at the applicator 13 or on the outlet line 44.

The gas supply channel 20 is apt to supply gas to the inlet 26, more particularly air, e.g. compressed air.

The solvent supply channel 22 is apt to supply solvent to the inlet 26, e.g. from a solvent tank 38 containing solvent.

In one embodiment, the solvent supply channel is a component supply channel, as described herein above, the multi-component product comprising solvent.

The gas supply channel 20 and the solvent supply channel 22 meet e.g. upstream of the inlet at a connection point, the connection point being connected to the inlet. The connection point is e.g. the same as the connection point of the component product supply channels 16, 18, all the supply channels meeting at said connection point.

Alternatively, each supply channel 16, 18, 20, 22 is connected to the inlet 26 separately from one another.

The gas supply channel 20 is provided with a gas valve 40.

More particularly, in the example shown, the gas valve 40 is arranged at the upstream end of the gas supply channel 20.

The gas valve 40 is e.g. apt to take gas, more particularly air, from the atmosphere surrounding the metering device 10.

The gas valve 40 is arranged upstream of the inlet 26, more particularly upstream of the connection point, where appropriate.

The gas valve 40 has at least one closed configuration, wherein the valve prevents the passage of gas through the valve 40 to the inlet 26, and at least one open configuration, wherein the valve permits the passage of gas through the valve 40 to the inlet 26.

As described hereinabove with respect to the valves 34, 36, the gas valve 40 has e.g. a closed configuration and a plurality of open configurations, or alternatively only a closed configuration and an open configuration.

The solvent supply channel 22 is provided with a solvent valve 42.

The solvent valve 42 is arranged upstream of the inlet 26, more particularly upstream of the connection point, where appropriate.

The solvent valve 42 is herein arranged downstream of the solvent tank 38.

The solvent valve 42 has at least one closed configuration, wherein the valve prevents the passage of solvent through the valve 42 to the inlet, and at least one open configuration, wherein the valve permits the passage of solvent through the valve 42 to the inlet 26.

As described hereinabove with respect to the valves 34, 36, the solvent valve 42 has e.g. a closed configuration and a plurality of open configurations, or alternatively only a closed configuration and an open configuration.

The application device 12 further comprises an outlet line 44.

The outlet line 44 extends herein between an upstream end and a downstream end.

The outlet line 44, more particularly the upstream end, is connected to the outlet 28 of the metering pump 14.

The downstream end is connected to the applicator 13.

More particularly, the metering pump 14 expels the product contained in the metering pump into the outlet line 44.

The metering device 10 further comprises a mixer 45, herein a mechanical mixer, more particularly a static mixer, downstream of the outlet 28 of the metering pump, more particularly arranged adjacent to the outlet 28 of the metering pump.

The mixer 45 is herein arranged in the outlet line 44, more particularly at the upstream end of the outlet line 44.

The metering device 10 is further provided herein with a sensor 46 of the volume entering the metering pump 14 or a sensor of the movement of the metering pump 14.

In the example shown, the sensor 46 is apt to and arranged to measure the movement of the piston of the metering pump 14.

Alternatively, the sensor 46 is apt to detect a parameter relating to the metering pump, said parameter depending directly on the volume entering the metering pump 14.

Additionally or alternatively, the sensor 46 is arranged at the inlet 26 and measures the volume of fluid entering the metering pump 14 via the inlet 26.

The sensor 46 provides e.g. an analog signal, e.g. the incoming volume or the movement of the piston.

Alternatively, the sensor 46 provides a digital signal, e.g. a notch or corresponding to a threshold of movement of the piston or of incoming volume.

The electronic device 24 comprises an information processing unit consisting e.g. of a memory and of a processor associated with the memory.

The electronic device 24 comprises a control unit 48.

The control module 48 is apt to control the respective valves 34, 36 of the supply channels, more particularly as described thereafter.

The control module 48 is e.g. connected to the valves 34, 36, e.g. by wire or by a remote connection.

The control module 48 is further apt to control the gas valve 40 and the solvent valve 42, where appropriate.

The control module 48 is e.g. connected to the valves 40, 42, e.g. by wire or by a remote connection.

The response time for each of the valves 34, 36, 40, 42 from the command of the control module 48 is comprised between 100 and 250 milliseconds.

The control module 48 is configured to implement the suction as described in the metering method described thereafter.

The control device 24 further comprises a monitoring module 50.

The monitoring module 50 is connected to the control module 48.

The monitoring module 50 is further connected to the sensor 46, e.g. by wire or by a remote connection.

More particularly, the monitoring module 50 is suitable for receiving information from the sensor 46, more particularly the signal supplied by the sensor 46 comprising the measurements made by the sensor 46.

The monitoring module 50 is apt to determine the quantity of volume entering the metering pump 14 and the nature of the fluid entering the pump 14, depending upon the configuration of each of the valves.

The monitoring module 50 is then apt to determine the quantity of each fluid entering the metering pump 14 successively.

The control module 48 and, where appropriate, the monitoring module 50 are each produced in the form of a software, or a software brick which can be executed by the processor. The memory of the electronic device is then apt to store a control software and a monitoring software. The processor is then apt to execute each of the software programs among the control software and the monitoring software.

In a variant (not shown), the control module 48 and, where appropriate, the monitoring module 50 are each produced in the form of a programmable logic component, such as an FPGA (Field Programmable Gate Array), or else an integrated circuit, such as an ASIC (Application Specific Integrated Circuit).

When the electronic device is produced in the form of one or a plurality of software programs, i.e. in the form of a computer program, same is further apt of being recorded on a computer-readable medium (not shown). The computer-readable medium is e.g. a medium apt to store the electronic instructions and to be coupled to a bus of a computer system. As an example, the readable medium is an optical disk, a magneto-optical disk, a ROM, a RAM, any type of non-volatile memory (e.g. FLASH or NVRAM) or a magnetic card. A computer program containing software instructions is then stored on the readable medium.

In the example shown in FIG. 1, the fluid is sucked in by the metering pump 14 during the suction phase by a so-called passive suction, i.e. during the suction phase, the metering pump 14 creates a negative pressure at the & inlet 26 thereof, which attracts a fluid, more particularly the fluid(s) coming from a channel the corresponding valve of which is in the open configuration.

Such a device is particularly simple.

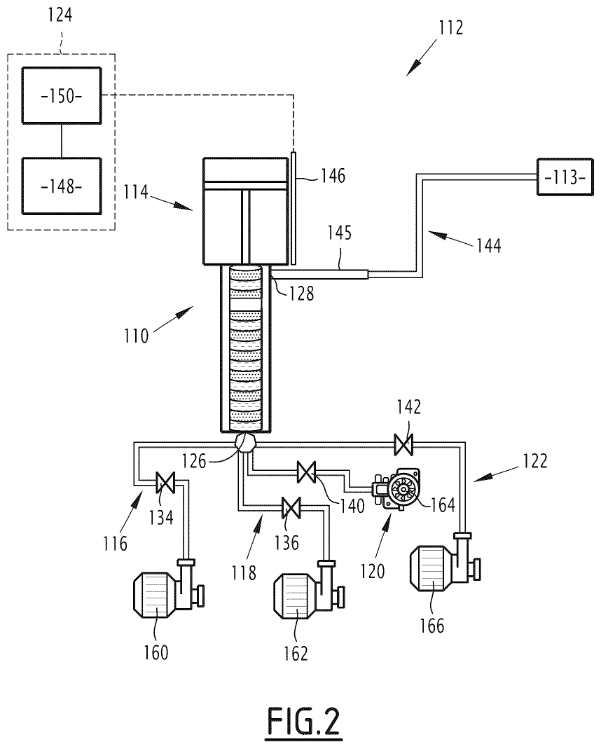

A second example of a metering device 110 for a multi-component coating product for application according to a second embodiment of the invention will now be described with reference to FIG. 2.

Only the features by which the second embodiment differs from the first embodiment will be described hereinafter in the description. With the exception of such features, the metering device 110 is moreover identical to the first example of a metering device.

Identical or similar elements have the same number reference incremented by 100.

In the second embodiment, each component product supply channel 116, 118 comprises a respective secondary pump 160, 162, the respective secondary pump 160, 162 being suitable for pumping the respective component product toward the inlet 126 of the metering pump 114.

Each respective secondary pump 160, 162 is arranged upstream of the respective valve 134, 136 of the supply channel 116, 118.

Each respective secondary pump 160, 162 is e.g. arranged downstream of a respective tank (not shown).

The gas supply channel 120 is provided with a compressor 164, the compressor 164 being suitable for compressing the gas toward the inlet 126 of the metering pump 114.

The compressor 164 is arranged upstream of the gas valve 140.

The compressor 164 is, more particularly, apt to take gas, more particularly air, from the atmosphere surrounding same, and to compress said gas in the gas supply channel 120 upstream of the gas valve 140.

The solvent supply channel 122 is provided with a secondary solvent pump 166, the secondary solvent pump 166 being adapted to pump the solvent to the inlet 126 of the metering pump 114.

The secondary solvent pump 166 is arranged upstream of the solvent valve 142.

The secondary solvent pump 166 is e.g. arranged downstream of a solvent tank (not shown).

In the example shown in FIG. 2, the fluid is sucked in, during the suction phase, by the metering pump 114 by a so-called active suction, i.e. the fluid is pushed toward the inlet 126 by the corresponding secondary pump or the compressor. During the suction phase, the metering pump 114 then sucks in the pushed fluid, more particularly the fluid or fluids coming from a channel the corresponding valve of which is in the open configuration.

A metering method for a multi-component coating product for application will now be described.

The metering method comprises the following steps:
supply of a metering device 10, 110 such as described hereinabove; and
suction by the metering pump 14, 114 of a volume during a suction phase of the metering pump 14, 114.

More particularly, the metering method comprises such a suction step during each of the suction phases of the metering pump 14, 114.

During suction, at least two of the respective valves 34, 36; 134, 136 of the supply channels 16, 18; 116, 118 are alternately, one after the other, in the open configuration, so that the volume sucked-in during said suction phase alternately comprises a plurality of component products.

The control module 48, 148 implements the suction step by successive control of the valves.

A plurality of component products form the multi-component product.

The multi-component product herein consists of a given number of component products.

In a particular embodiment, the multi-component product herein consists of a given number of component products in predetermined proportions.

During suction, the valves 34, 36; 134, 136 of the supply channels 16, 18; 116, 118 corresponding to said component products of the given number of component products are alternately placed, one after the other, in the open configuration.

The minimum sucked-in volume of one of the component products or of solvent during a valve opening is e.g. greater than or equal to 0.5 cubic centimeter, more particularly greater than or equal to 1 cubic centimeter, more particularly comprised between 1 and 20 cubic centimeters.

The maximum sucked-in volume of one of the component products or f solvent during a valve opening is e.g. less than or equal to 1000 cubic centimeter, more particularly comprised between 100 and 1000 cubic centimeter.

At any time, at most one valve of the gas or solvent supply channels is open at a time.

Here, suction comprises, in the present order, the following steps:
opening of a first valve in the supply channel of a first component product;
suction of the first component product by the metering pump for suction of a first volume;
closing of the first valve;
opening of a second valve in the supply channel of a second component product;
suction of the second component product by the metering pump for suction of a second volume;
closing of the second valve; and
so on until the valve of the given number, said preceding steps being repeated throughout the suction phase.

The first volume and the second volume herein remain respectively identical between the iterations of the preceding steps.

Alternatively, the suction steps are implemented according to a duration: the first component product is sucked in for a first duration, and the second component product is sucked in for a second duration, the first duration and the second duration remaining respectively identical between the iterations of the steps.

During the suction phase, each valve of a product composing the multi-component product is, in turn, opened and then closed, thereof being repeated throughout the duration of the suction phase of the metering pump 14, 114.

The suction herein comprises a suction cycle.

During a suction cycle, at least two of the respective valves are, in turn, in the open configuration.

More particularly, during a suction cycle, at least two of the respective valves are, in turn, opened and then closed.

Said suction cycle is reiterated throughout the suction phase.

Thereby, the volume sucked in by the metering pump 14, 114 during each of the suction phases thereof comprises an alternation of component products in the form of slices, which are repeated along the sucked in volume.

If at the end of a suction phase a suction cycle is in progress, the suction cycle will resume where same stopped, during the following suction phase.

For example, for a suction volume of the pump of 100 cc, if the volume of the first component product to be sucked in is 1 cc and the volume of the second component product is 51 cc, then, during the first suction phase, same is, e.g., sucked in successively: 1 cc of the first component product, 51 cc of the second component product, 1 cc of the first component product, then only 47 cc of the second component product. Thereby, the second suction phase begins with the suction of 4 cc of the second component product, then resumes a suction cycle, and so on.

In a particular embodiment, during a suction cycle, the volume of each respective component product sucked-in is equal to the product of a respective predetermined ratio and the total volume of respective component products sucked-in during the suction cycle, the sum of the respective ratios being equal to 1.

The respective ratio corresponds to the predetermined proportion of said component product in the multi-component product.

More particularly, the valve of a component product being sucked in is moved into a closed configuration, more particularly by the control module 48, when the volume of said component product is equal to the product of a respective predetermined ratio and of the total volume of respective component products sucked in during the suction cycle.

The product at the outlet 28, 128 of the metering pump 14, 114 is then in the proportions desired for the multi-component product.

For example, for a multi-component product comprising products A and B in a ratio of 1:100, then the respective ratio herein is 1/101 for product A and 100/101 for product B. If a given volume of product A is sucked in, same is then sucked in 100 times said given volume of product B.

The metering method advantageously comprises a detection of the volume sucked in during the suction by the metering pump 14, 114, more particularly by the sensor 46, 146.

During suction, the monitoring module 50, 150 of the electronic device 24, 124 is then apt to determine the quantity of each fluid entering successively the metering pump 14, 114.

During suction, when a component product is sucked in by the metering pump 14, 114, when the quantity of component product sucked in, monitored by the monitoring module 50, 150, reaches the desired quantity, the control module 48, 148 then sends an instruction to the corresponding valve to switch to the closed configuration, and then e.g. sends an instruction to the next valve to switch to the open configuration.

In the example described hereinabove, during suction, the metering pump 14, 114 further expels a portion, herein half the cylinder capacity of the metering pump, of fluid at the outlet 28; 128 toward the outlet line 44; 144.

When the metering pump comprises a suction phase and a phase without suction, during the phase without suction, the valves 34, 36, 134, 136 and, where appropriate, 40, 42, 140, 142 are in the closed configuration if the target volume was successfully sucked-in during the preceding suction phase. More particularly, the control module 48, 148 sends a signal to the valves 34, 36, 134, 136 and, where appropriate, 40, 42, 140, 142 to move into the closed configuration, if same are not already in the closed configuration.

If the target volume of the fluid being sucked-in at the end of the suction phase has not been sucked-in during a suction phase, then the corresponding valve remains open during the phase without suction until the supplement is sucked-in as soon as the beginning of the next suction phase.

Thereby, the metering method comprises alternately a suction step and a step without suction.

During the step without suction, in the example described hereinabove, the metering pump expels a supplementary portion of the portion expelled during suction, herein half the cylinder capacity of the metering pump, of fluid at the outlet 28.

In the example described hereinabove, during suction, the metering pump 14, 114 also expels a portion, herein half the cylinder capacity of the metering pump, of fluid at the outlet 28.

By alternating the component products in the inlet volume of the metering pump, it is possible to have the different components directly one after the other, cyclically, which enhances mixing.

More particularly, in the case of a piston pump as described hereinabove, the movement of the piston head already produces a pre-mixing between the slices in the metering pump.

Thereof then makes possible an improved mixing of the multi-component product.

1. A metering method for a multi-component coating product for application, the metering method comprising the following steps:
supply of a metering device comprising a metering pump and a plurality of respective component product supply channels, the metering pump having an inlet and an outlet, the inlet being connected to the respective plurality of component product supply channels, each component product supply channel being provided with a respective valve, each valve having at least one closed configuration, wherein the valve prevents the passage of the corresponding component product to the inlet, and at least one open configuration, wherein the valve permits the passage of the corresponding component product to the inlet, the outlet being suitable for being connected to a coating product applicator; and
suction by the metering pump of a volume during a suction phase of the metering pump, at least two of the respective valves being alternately, one after the other, in the open configuration during suction, so that the volume sucked-in during said suction phase alternately comprises a plurality of component products, wherein the suction comprises a suction cycle, said suction cycle being reiterated throughout the suction phase, at least two of the respective valves being one after the other in the open configuration during the suction cycle, and wherein, if at the end of a suction phase a suction cycle is in progress, the suction cycle resumes where it was interrupted, during a following suction phase.

2. The metering method according to claim 1, wherein the metering device comprises at least two respective component product supply channels, a gas supply channel, and a solvent supply channel.

3. The metering method according to claim 1, wherein the multicomponent product consists of a given number of component products, the suction comprising, in the present order, the following steps: opening of a first valve in the supply channel of a first component product, suction of a first volume of the first component product by the metering pump, closing of the first valve, opening of a second valve in the supply channel of a second component product, suction of a second volume of the second component product by the metering pump, closing of the second valve, and so on until the valve of the given number, said preceding steps being repeated throughout the suction phase.

4. The metering method according to claim 1, wherein during a suction cycle, the volume of each respective component product sucked in is equal to the product of a respective predetermined ratio and the total volume of respective component products sucked in during the suction cycle, the sum of the respective ratios being equal to 1.

5. The metering method according to claim 1, comprising a detection of the suction volume during the suction by the metering pump.

6. The method according to claim 5, wherein the detection of the suction volume is done by a sensor of sucked-in volume or a sensor of the movement of the metering pump.

7. The metering method according to claim 1, wherein the metering pump is a piston pump.

8. The metering method according to claim 1, wherein each component supply channel of the metering device comprises a respective secondary pump, the respective secondary pump being suitable for pumping the respective component product to the inlet of the metering pump, each respective secondary pump being arranged upstream of the respective valve of the component product supply channel.

9. The metering method according to claim 1, wherein the metering device comprises a mixer downstream of the outlet of the metering pump.

10. The metering method according to claim 9, wherein the mixer is arranged adjacent to the outlet of the metering pump.

11. A metering device for a multi-component product, comprising a metering pump, a plurality of supply channels for the respective component product and a control module, the metering pump having an inlet and an outlet, the inlet being connected to the respective plurality of component product supply channels, each component product supply channel being provided with a respective valve, each valve having at least one closed configuration, wherein the valve prevents the passage of the corresponding component product to the inlet, and at least one open configuration, wherein the valve permits the passage of the corresponding component product toward the inlet, the outlet being suitable for being connected to a coating product applicator, the control module being suitable for controlling the respective valves, the control module being configured to implement suction according to the suction step of the method according to claim 1.

12. An application device for a multi-component coating product comprising a metering device according to claim 11 and a coating product applicator, the coating product applicator being connected to the outlet of the metering pump, so that the metering pump supplies the coating product applicator.
